(19) United States
(12) Patent Application Publication
(10) Pub. No.: US 2010/0241577 A1
(43) Pub. Date: Sep. 23, 2010

(54) Method for Routing Users to Contact Center Agents

(75) Inventors: Birgit Andrea Geppert, Basking Ridge, NJ (US); Reinhard Peter Klemm, Basking Ridge, NJ (US); Frank Michael Roessler, Basking Ridge, NJ (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/724,971

(22) Filed: Mar. 16, 2010

Related U.S. Application Data
(60) Provisional application No. 61/160,779, filed on Mar. 17, 2009.

(51) Int. Cl. G06Q 10/00; G06Q 99/00; G06F 3/048; G06F 15/16

(52) U.S. Cl. 705/304; 705/319; 715/810; 709/227

(57) ABSTRACT

A method is provided in which a user selects the characteristics of an agent with which the user wants to talk. The user is allowed to add a selection of agent characteristics to an online “shopping cart” and transmit the content of the shopping cart to the contact center. The contact center uses the transmitted information to find an appropriate agent for the user. The method can be provided as part of a preferential treatment of users. In accordance with some embodiments of the present invention, preferential treatment is provided on the basis of one of: (1) a characteristic of a user, (2) a characteristic of a transaction in which the user participated, (3) the availability of a selection of agent characteristics which was made by the user in a prior session with the contact center.

### CROSS-REFERENCE TO RELATED APPLICATIONS

This application claims the benefit of U.S. provisional application Ser. No. 61/160,779, filed Mar. 17, 2009, entitled Direct Agent Skill Class Request and Multiple Request Processing/Favorites (Attorney Docket 630-466us), which is also incorporated by reference.

### FIELD OF THE INVENTION

The present invention relates to communications in general, and, more particularly, to contact center technology.

### BACKGROUND OF THE INVENTION

A contact center is a telecommunications system that connects customers to customer service agents. When customers need assistance, they call a customer service number that connects them to a contact center. The contact center processes the calls and connects the customers to agents.

In connecting customers to agents, contact centers ordinarily use interactive communication scripts. Interactive communication scripts are sets of commands that define how calls are to be processed. Their execution results in customers being presented with user-selectable menus. Such menus allow the customers to specify their preference of a language as well as share information about the reason for their call.

The use of interactive communication service scripts, however, comes at a cost. The content of the menus provided by interactive communication scripts can be confusing and their number overwhelming. Sometimes, customers traverse long series of menus without succeeding to reach a human agent. The time which it takes to navigate through each of the menus and the lack of result combine to produce a negative experience for these customers.

Businesses, as a rule, would like to avoid negative customer experiences. At the same time, their desire to satisfy the customer is counterbalanced by the purpose to generate profit. The quality of service of contact centers is, therefore, at tension with the need of businesses to run contact centers efficiently.

For instance, an easy solution to the problems of excessive automation, an example of which is described above, is to hire more human agents. This, however, is not practical because it would increase the operating costs of contact centers. Therefore, the need exists for methods which address the problems of excessive automation without increasing operating costs.

### SUMMARY OF THE INVENTION

The present invention addresses this need by using a two-speared approach. First, the present invention provides a method for routing users to contact center agents that avoids the problems that are inherent in using interactive communication scripts. And also, the present invention provides a method for providing users with preferential treatment. In this way, the present invention can ensure that customers who are the most valuable to business are spared from the elements of excessive contact center automation.

In a first embodiment of the present invention, a method is provided in which a user selects the characteristics of an agent with whom the user wants to communicate. For example, if a user is calling a contact center in relation to a sound problem with a computer, the user can ask to speak to an agent who (1) speaks Spanish, (2) has a college degree, and (3) is familiar with audio problems that arise in the Windows™ operating system. The user adds this selection of characteristics to a “shopping cart” and transmits its content to the contact center. The contact center provides the set of possible characteristics and may also allow the customer to add characteristics. The contact center, in turn, does its best to select an agent who matches the characteristics.

The method of the first embodiment can be easily contrasted with the operation of contact centers that are known in the art. Ordinarily, contact centers ask the user about the purpose of his or her call and, based on this information, they deduce the agent skills that are needed for assisting the user. The first embodiment, in contrast, allows users to specify the characteristics which they desire in an agent directly. Under this arrangement, a user need not traverse a long series of menus that ask the user about the nature of his or her call. Rather, the user can provide a set of agent characteristics to a contact center and let the contact center match this information against characteristics that are possessed by available agents.

Admittedly, it may not always be practicable for contact centers to let users choose the characteristics which they desire in the assisting agents. It is conceivable that users will gravitate towards agents who are most skilled while leaving agents who are less skilled, but nevertheless capable of assisting the users, underutilized. The method of the first embodiment, in other words, has the potential to skew the distribution of the load placed on different agents at a contact center.

For this reason, the second embodiment of the present invention provides a method for providing a preferential treatment to users. The second embodiment of the present invention allows contact centers to provide selected users with a treatment that would otherwise stretch their resources if provided to everyone. Examples of users which contact centers might want to provide with preferential treatment are the early adopters and high-income users.

Early adopters are users who are first to purchase products when they are released on the market. They embrace new technology before other people do. They are important to businesses because they act as trend-setters and also because they are capable of providing useful feedback on how to improve the businesses's products. High-income customers are people with above-average disposable income. The high-income customers are important because they spend more.

In accordance with the second embodiment of the present invention, preferential treatment is provided on the basis of one of:
(1) a characteristic of a user,
(2) a characteristic of a transaction in which the user participated,
(3) the availability of a selection of an agent characteristic which was made by the user in a prior session with the contact center, and
(4) any other precondition that is described in this disclosure.

For the purposes of this disclosure, the term “user characteristic” is defined as an item of information about a user who reaches a contact center. Additionally, for the purposes of this disclosure, the term “transaction characteristic” is defined as an item of information about a transaction in which the user participated.

The preferential treatment is provided in at least one of the following methods:
(1) an agent is deliberately selected to serve a user,
(2) the execution of an interactive communication script is bypassed for the user,
(3) a customer service script from which agents read is customized for the user,
(4) the user is allowed to personally specify a characteristic of an agent to whom the user wishes to be connected,
(5) the user is presented with a set of agent profiles and allowed to select the agent to whom the user wishes to be connected,
(6) an Internet search is performed to obtain information about the user, and
(7) any other method described in this disclosure.

In accordance with a first instance of the second embodiment, an agent is deliberately selected to serve a user. The agent is selected on the basis of an agent characteristic. For the purposes of this disclosure, the term “agent characteristic” is defined as an item of information about an agent. An example of an agent characteristic is an agent skill (e.g., agent has an advanced degree, etc.). The first instance of the second embodiment allows contact centers to connect users who are deemed important to agents that are the most skilled.

In accordance with a second instance of the second embodiment, the execution of an interactive customer script is bypassed. That is, the user is either connected to a live operator or allowed to specify a set of desired agent characteristics. When the user is connected to a live operator, the operator may perform the information gathering functions which are ordinarily performed by interactive communication scripts. Since live operators are more responsive than automated systems, the users who are connected to live operators are considered to be provided with a higher quality of service.

In accordance with a third instance of the second embodiment, a customer service script is modified. A customer service script is a script from which customer service agents read when assisting customers. For example, when a user is an early adopter of a product, the customer service script is modified to include a survey about the product. Thus, the third instance of the second embodiment allows contact centers to gather valuable information from specified users.

In accordance with a third embodiment of the present invention, publicly available Internet records, such as profiles available on social networks (e.g., Myspace™, Linkedin™, are mined for information. In particular, information about at least one of (1) a user characteristic, (2) agent characteristic, and (3) transaction characteristic is extracted from the profiles. The extracted information is then used to select a contact center agent. In other words, the third embodiment of the present invention mines the internet for information which is then used in matching users to contact center agents.

It is to be understood, that the above embodiments and their instances are provided to better illustrate different aspects of the present invention. They are in no way exhaustive of the full scope of the invention. The following disclosure teaches examples of some embodiments of the present invention in detail.

### BRIEF DESCRIPTION OF THE DRAWINGS

FIG. 1 depicts a schematic diagram of the salient components of the illustrative embodiment of the present invention.

FIG. 2 depicts a schematic diagram of the salient components of the illustrative embodiment of the present invention.

FIG. 3 depicts a schematic diagram of the salient components of the illustrative embodiment of the present invention.

FIG. 4 depicts a flowchart of the execution of the salient tasks associated with the operation of the illustrative embodiment of the present invention.

FIG. 5 depicts a flowchart of the execution of the salient subtasks associated with the performance of task 410.

FIG. 6 depicts a flowchart of the execution of the salient subtasks associated with the performance of task 520.

FIG. 7 depicts a flowchart of the execution of the salient subtasks associated with the performance of task 425.

FIG. 8 depicts a flowchart of the execution of the salient subtasks associated with the performance of task 435.

FIG. 9 depicts a flowchart of the execution of the salient subtasks associated with the performance of task 430 by a first illustrative embodiment of the present invention.

FIG. 10 depicts a flowchart of the execution of the salient subtasks associated with the performance of task 430 by a second illustrative embodiment of the present invention.

FIG. 11 depicts a flowchart of the execution of the salient subtasks associated with the performance of task 430 by a third illustrative embodiment of the present invention.

FIG. 12 depicts a flowchart of the execution of the salient subtasks associated with the performance of task 1010 by a fourth illustrative embodiment of the present invention.

FIG. 13 depicts a flowchart of the execution of the salient subtasks associated with the performance of task 1010 by a fourth illustrative embodiment of the present invention.

FIG. 14 depicts a graphical user interface (GUI) window which allows user 101-5 to select specific available skills.

FIG. 15 depicts customer service script template 1301, introductory statements pool 1720, and conclusion pool 1730.

FIG. 16 depicts an example of a modified customer service script.

FIG. 17 depicts a flowchart of the execution of the salient subtasks associated with the performance of task 1010 by a fifth illustrative embodiment of the present invention.

FIG. 18 depicts a graphical user interface (GUI) 1810 for the viewing of agent profiles.

### DETAILED DESCRIPTION

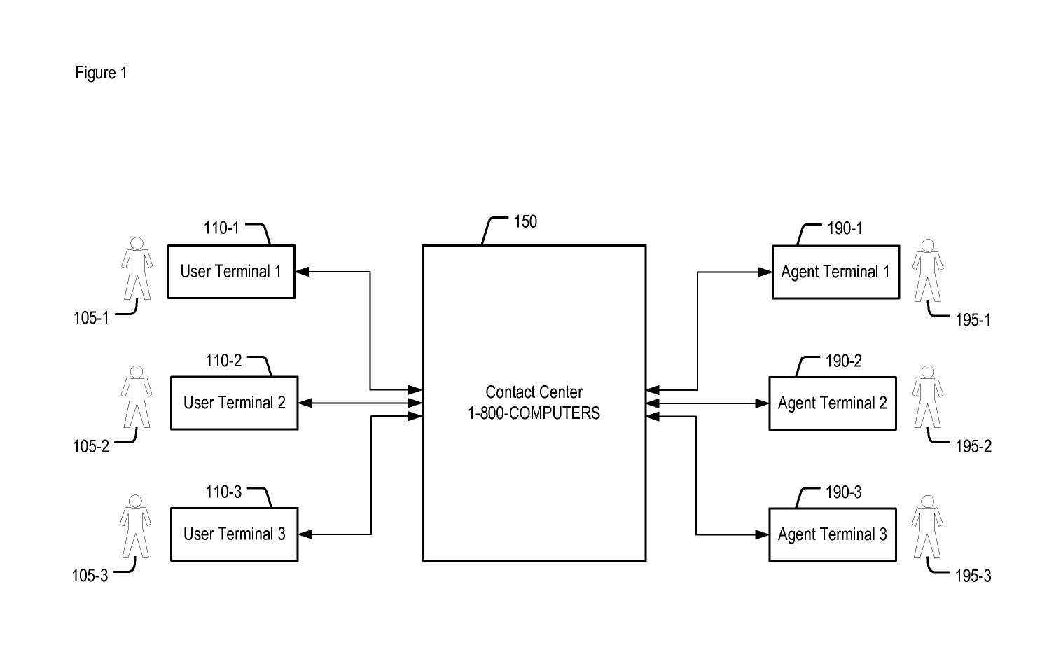

FIG. 1 depicts a schematic diagram of the salient components of the illustrative embodiment of the present invention. The illustrative embodiment comprises user terminal(s) 110-i, contact center 150, and agent terminal(s) 190-i, where I∈{1, 2 and 3}.

Although FIG. 1 depicts only three user terminals as being connected to contact center 150, those skilled in the art will readily recognize, after reading this disclosure, that any number of terminals can be connected to the contact center (e.g., 1, 3, 30, 300, 1000, etc.). Furthermore, it will be clear to those skilled in the art, after reading this disclosure, that any number of agent terminals and agents can be serving calls that are received at contact center 150 (e.g., 1, 5, 50, 500, etc.).

User terminal 110-i, three of which terminals are depicted in FIG. 1, is a communications terminal. In accordance with the illustrative embodiment of the present invention, user terminal 110-i is a desk-set telephone receiver, but it will be clear to those skilled in the art, after reading this disclosure, how to make and use alternative embodiments of the present invention in which user terminal 110-i is another type of communications terminal, such as, for example, and without limitation, cellular telephone, personal computer, portable gaming device, and others.

Agent terminal 190-i, three of which terminals are depicted in FIG. 1, is a communications terminal. In accordance with the illustrative embodiment of the present invention, agent terminal 190-i is a desktop computer, but it will be clear to those skilled in the art, after reading this disclosure, how to make and use alternative embodiments of the present invention in which agent terminal 190-i is another type of communications terminal, such as, for example, and without limitation, desk-set telephone receiver, cellular telephone, portable gaming device, personal computer, and others.

Contact center 150 is a communications system that connects user terminal 110-i to agent terminal 190-i. In accordance with the illustrative embodiment of the present invention, contact center 150 is an automated call distribution (ACD) center, but it will be clear to those skilled in the art, after reading this disclosure, how to make and use alternative embodiments of the present invention in which contact center 150 distributes another type of communications, such as, for example, and without limitation, incoming Internet chat requests, incoming video calls, incoming emails, incoming text messages, etc.

Agent 195-i, three of whom are depicted in FIG. 1, is a natural person that operates agent terminal 190-i. More specifically, in accordance with the illustrative embodiment of the present invention, agent 195-i is a customer service representative. However, it will be clear to those skilled in the art, after reading this disclosure, that agent 195-i can be any type of live telephone operator (e.g., 911 emergency personnel dispatcher, etc.). Furthermore, it will be clear to those skilled in the art, after reading this disclosure, how to make and use alternative embodiments of the present invention in which agent 195-i is software that is capable of interacting with callers (e.g., an interactive voice response (IVR) system, etc.).

User 105-i is a person who connects to contact center 150 in order to obtain assistance from agent 195-i. In accordance with the illustrative embodiment of this invention, user 105-i is a customer who calls in relation to a consumer product, but it will be clear to those skilled in the art that user 105-i can be any person who for any reason connects to contact center 150. When user 105-i is connected to contact center 150, the user is provided with one of two types of treatment: (1) a standard treatment or (2) a preferential treatment.

The standard treatment is what the name suggests—it is the type of treatment that is ordinarily provided by contact centers known in the art. It involves connecting the user with an interactive voice response (IVR) system, obtaining information from the user, and based on the information, connecting the user to an agent. Notably, in the standard treatment, a user is routed to a waiting queue that is served by several agents. The user speaks to whoever of the agents becomes available first.

The preferential treatment, in contrast, is a treatment that is specific to the present invention. The preferential treatment is provided in one of several methods:
(1) an agent is deliberately selected to serve user 105-i,
(2) the execution of an interactive communication script is bypassed for user 105-i,
(3) a customer service script from which agents 190-i read is customized for the user,
(4) the user is allowed to personally specify the characteristics of an agent to whom the user wishes to be connected,
(5) the user is presented with a set of agent profiles and allowed to select the agent to whom the user wishes to be connected,
(6) an Internet search is performed to obtain information about the user, and
(7) any other method described in this disclosure.
   The methods in which users are provided with preferential treatment by contact center 150 are described in detail in the remaining disclosure.

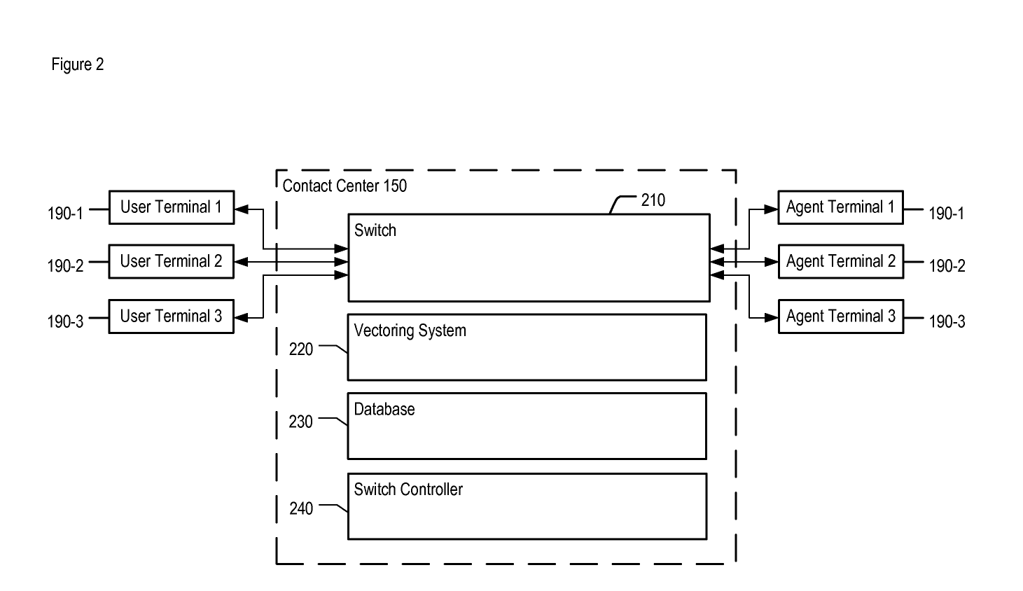

FIG. 2 depicts a schematic diagram of the salient components of the illustrative embodiment of the present invention. The illustrative embodiment comprises user terminal(s) 110-i, contact center 150, agent terminal(s) 190-i, switch 210, vectoring system 220, database 230, and switch controller 240.

FIG. 2 depicts the internal structure of contact center 150. Although contact center 150 is depicted as a monolithic system, those skilled in the art will readily recognize that alternative embodiments of the present invention can be devised in which contact center 150 is a collection of discrete components (e.g., servers, switches, storage devices, database servers, etc.). It will be clear to those skilled in the art, after reading this disclosure, how to make and use alternative embodiments of the present invention in which any one of vectoring system 220, database 230, and switch controller 240 is hosted on one or more servers that are separate from the other components of contact center 150.

Switch 210 is a communications switch for setting up communications connections between user terminal 110-i, agent terminal 190-i, and vectoring system 220. Although, FIG. 2 depicts a single switch, it will be clear to those skilled in the art, after reading this disclosure, how to make and use alternative embodiments of the present invention in which a plurality of switches is used.

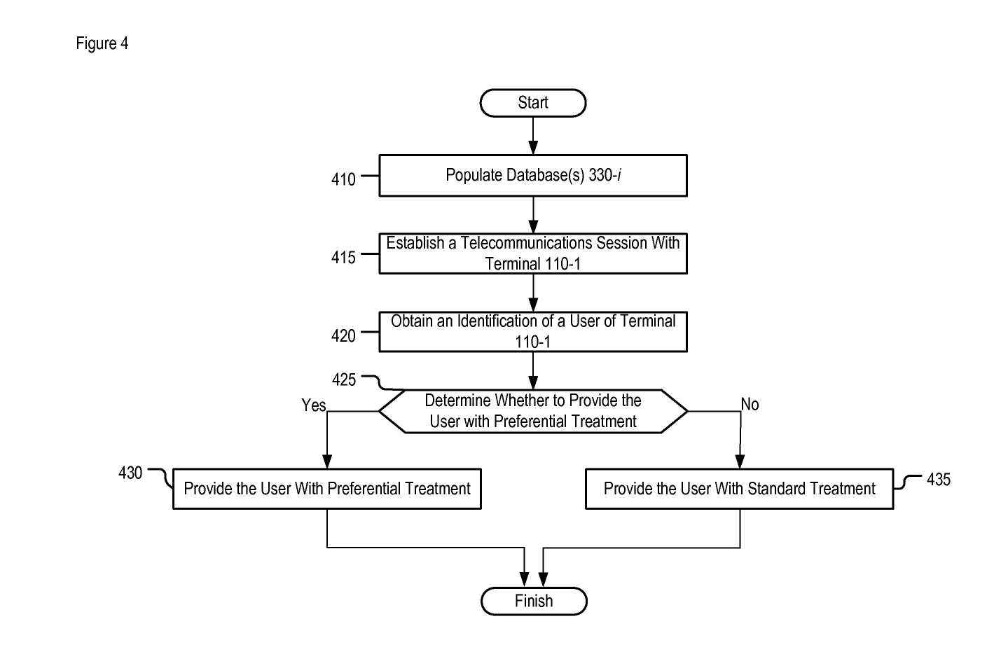

Vectoring system 220 is a hardware and software system for routing users who reach contact center 150. Routing is the process of selecting one or more agents who are best suited to serve a user. In the illustrative embodiment of the present invention. the routing operations performed by vectoring system 220 conclude with one of two actions: (1) vectoring system 220 places an identifier corresponding to user 105-i in one of queues 340-j and lets the user wait for an agent to become available, or (2) vectoring system connects user 105-i to one of agents 195-i without placing the user in the waiting queues. The functions performed by vectoring system 220 are described further in the discussions with respect to FIGS. 4-11.

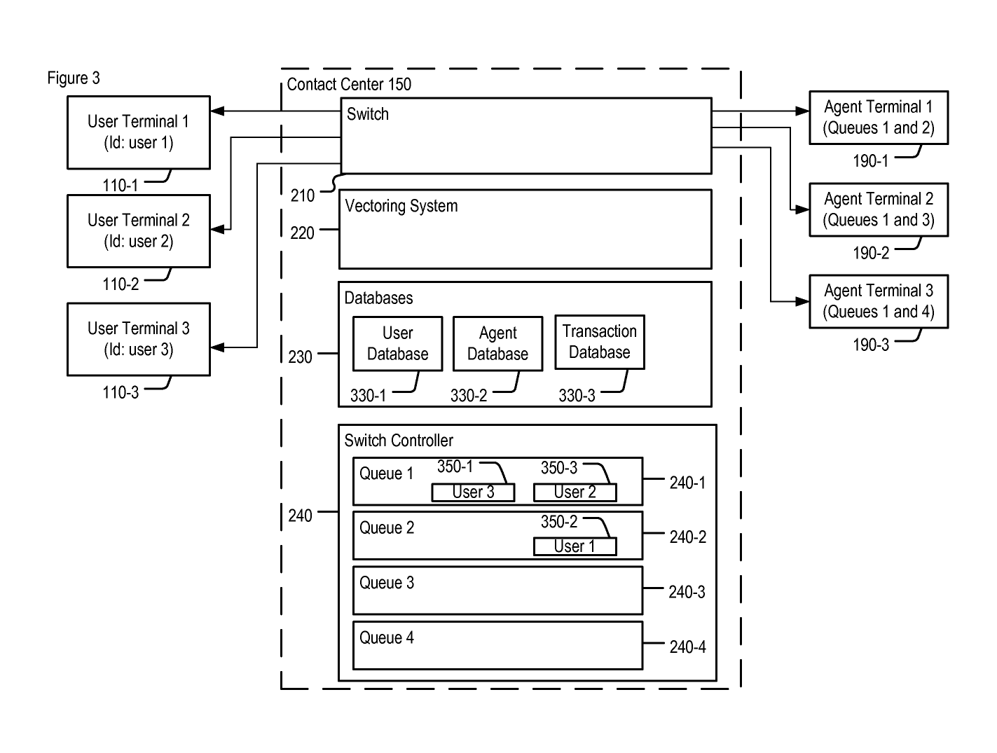

Database 230 is a set of one or more databases that store information which is used by vectoring system 220 in the routing of users 105-i. In accordance with the illustrative embodiment of the present invention, database 230 comprises three individual databases—a database that stores information about users 105-i, database that stores information about agent 195-i, and database which stores information about transactions in which users 105-i have participated. The three databases are further described in the discussion with respect to FIG. 3.

Switch controller 240 is hardware and software for controlling switch 210. Additionally, switch controller 240 is responsible for managing queues 340-j and connecting users who are waiting in the queues with available agents. For instance, when an agent becomes available to communicate with a user, switch controller 240 receives an indication to that effect. The indication is transmitted either from the terminal of the agent or from switch 210.

Upon receiving the indication, switch controller 240 identifies one or more queues which are served by the agent whose terminal has become available. Then, switch controller 240 selects one of the identified queues and retrieves an identifier corresponding to a user from the front of the selected queue. After that, switch controller 240 instructs switch 210 to set up a communications session between the user terminal (or user) corresponding to the retrieved identifier and the terminal of the agent that has become available.

FIG. 3 depicts a schematic diagram of the salient components of the illustrative embodiment of the present invention. The illustrative embodiment comprises user terminal(s) 110-i, contact center 150, agent terminal(s) 190-i, switch 210, record(s) 350-i, vectoring system 220, and queue(s) 340-j where j∈{1, 2, 3, and 4}.

Database 230 comprises database 330-1, agent database 330-2, and transaction database 330-3 (collectively referred to as “database(s) 330-i). Although, the illustrative embodiment of the present invention uses databases and database records, it should be noted that the present invention is not limited in any way to this method of information storage. Those skilled in the art will recognize a variety of ways to store the information found in databases 330-i and relate it to agents 195-i or users 105-i, such as, for example, and without limitation, spreadsheets, text files, and others.

User database 330-1 is a database which stores an indication of at least one user characteristic. As noted in the Summary of Invention section, the term “user characteristic” is defined as an item of information about user 105-i. In accordance with the illustrative embodiment of the present invention, user database 330-1 comprises records which correspond to individual users. Table 1 shows an example of one such record:

TABLE 1
Example of a record of user database 330-1

| | |
|---|---|
| Name | John Customer |
| Telephone Number | 401-000-0000 |
| Address | 102 Maple Shade Drive, Freeport NJ |
| Age | 45 |
| Education | College |
| Frequency of Calling | 3 times/month |

As shown, in accordance with the illustrative embodiment of the present invention, the information records for user 105-i contain the legal name of the user, telephone number, address, age, education, and frequency at which the user calls contact center 150. However, it will be clear to those skilled in the art, after reading this disclosure, that alternative embodiments of the present invention can be devised in which any user characteristic is stored in user database 330-1, such as, for example, and without limitation, familial status, income, employer address, employment status, name of spouse, income, real estate ownership, etc.

Agent database 330-2 is a database which stores an indication of at least one agent characteristic. As noted in the Summary of Invention section, the term “agent characteristic” is defined as an item of information about agent 195-i. In accordance with the illustrative embodiment of the present invention, agent database 330-2 comprises records which correspond to individual agents. Table 2 shows an example of one such record:

TABLE 2
Example of a record of agent database 330-2

| | |
|---|---|
| Name | Peter Agent |
| Human Resources ID | 1378 |
| Division | Electronics Customer Support |
| Years of Experience | 10 years |
| Education | Masters of Science |
| Most Recent Performance Review | Extremely high |

As shown, in accordance with the illustrative embodiment of the present invention, the information records for agent 195-i contain the legal name of the agent, a human resources ID, identification of a division to which the agent belongs, level of experience of the agent, education of the agent, and an indication of the results from the most recent performance review of the agent. However, it will be clear to those skilled in the art, after reading this disclosure, that alternative embodiments of the present invention can be devised in which any agent characteristic is stored in agent database 330-2, such as, for example, and without limitation, languages spoken, gender, age, levels of expertise with respect to individual products or types of products (e.g., television sets—high expertise, home theater systems—low expertise, etc.), indication of skills possessed by the agent, and others.

Transaction database 330-3 is a database which stores an indication of at least one transaction characteristic. As noted in the Summary of Invention section, the term “transaction characteristic” is defined as an item of information about a transaction in which user 105-i participated. In accordance with the illustrative embodiment of the present invention, agent database 330-2 comprises records which correspond to individual transactions. Table 3 shows an example of one such record:

TABLE 3
Example of a record of transaction database 330-3

| Type of Transaction | Purchase of a Consumer Product |
|---|---|
| Type of Product Purchased | Blu-Ray Disk Player |
| Date Of Purchase | Jul. 1, 2006 |
| Price Paid | $500 |

As shown, in accordance with the illustrative embodiment of the present invention, the records in transaction database 330-3 contain information about a type of a product purchased, data of a purchase, and a price paid. However, it will be clear to those skilled in the art, after reading this disclosure how to make and use alternative embodiments of the present invention in which any type of information is stored in information records of transaction database 330-2. For example, and without limitation, such information can include credit card number to which the purchase was charged, a customer number for the purchaser, store location at which the purchase was executed, etc.

Furthermore, in accordance with the illustrative embodiment of the present invention, the records in transaction database 330-3 contain information about a purchase made by user 105-i. However, it will be clear to those skilled in the art, after reading this disclosure, how to make and use alternative embodiments of the present invention in which information about other types of transactions is stored such as financial or data transactions, for instance. Examples of financial transactions include money transfers, account withdrawals, etc. Examples of data transactions include fie upload and data deletion, among others.

Switch controller 240, as discussed, is responsible for managing queues 340-j and connecting users who are waiting in the queues with available agents. In accordance with the illustrative embodiment of the present invention, switch controller 240 manages four (4) queues, however, it will be clear to those skilled in the art, after reading this disclosure, how to make and use alternative embodiments of the present invention in which switch controller 240 manages any number of queues (e.g., 1, 5, 50, 500, etc.).

Queue(s) 340-j, two of which are depicted in FIG. 3, is a first-in-first-out (FIFO) data structure. In accordance with the illustrative embodiment of the present invention, queue 340-j is managed by switch controller 240, but it will be clear to those skilled in the art, after reading this disclosure, how to make and use alternative embodiments of the present invention in which queue 340-j is managed by another component of contact center 150, such as switch 210, for example. Furthermore, in accordance with the illustrative embodiment of the present invention, queue 340-j is stored in the memory of contact center 150. However, it will be clear to those skilled in the art, after reading this disclosure, how to make and use alternative embodiments of the present invention in which queue 340-j is stored at an alternative location, such as, for example, and without limitation, network access drive, storage device that is internal to switch 210, storage of a server hosting vectoring system 220, storage of a server hosting switch controller 240, etc.

Queue(s) 340-j contains records 350-j. In accordance with the illustrative embodiment of the present invention, the records store identifiers corresponding to user terminals 110-i. An identifier corresponding to a communications terminal is an identifier used by contact center 150 to identify a user terminal that is placed in queue 310-j. In accordance with the illustrative embodiment of the present invention, the identifier corresponding to a communications terminal is an endpoint identifier for one of user terminals 110-i. However, it will be clear to those skilled in the art, after reading this disclosure, how to make and use alternative embodiments of the present invention in which the identifier corresponding to a communications terminal is another item of information (e.g., legal name of user, caller account number, etc.). In its alternative embodiments, the present invention relies on translation tables to convert the identifiers corresponding to communications terminals to information that can be used by switch 210 in establishing communications sessions between user terminals 110-i and agent terminals 190-i (e.g., endpoint identifiers, switch port numbers, connection type information, internet protocol (IP) addresses, etc.).

Queue 340-1 is served by agents 195-1, 195-2, and 195-3. When one of the agents becomes available, switch controller 240 retrieves, from the front of queue 340-1, an identifier corresponding to a user terminal. Then, switch controller 240 instructs switch 210 to connect the user terminal to the terminal of the agent who has become available. In any event, it is important to note that when a user is placed in queue 340-1, that user would be served by one of agents 195-1, 195-2, and 195-3, depending on who becomes available first.

In contrast, queue 340-2, queue 340-3, and queue 340-4 are served by individual agents. The queues are served by agent 195-1, agent 195-2, and agent 195-3, respectively. In some of the embodiments of the present invention, when vectoring system 220 wants to ensure that a user is served by a specific agent, the vectoring system places the user in one of queues 340-2, 340-3, and 340-4.

FIG. 4 depicts a flowchart of the execution of the salient tasks associated with the operation of the illustrative embodiment of the present invention. In accordance with the illustrative embodiment of the present invention, the majority of tasks described in the discussion FIG. 4 are performed by vectoring system 220. However, it will be clear to those skilled in the art, after reading this disclosure, that tasks 410 through 435 and their underlying sub-tasks can be performed by any component of contact center 150, such as switch controller 240 for example.

Furthermore, it will be clear to those skilled in the art, after reading this disclosure, how to perform the tasks associated with FIG. 4 in a different order than represented or to perform one or more of the tasks concurrently. It will also be clear to those skilled in the art, after reading this disclosure, how to make and use alternative embodiments of the present invention that omit one or more of the tasks. Specifically, it will be clear to those skilled in the art how to make and use alternative embodiments of the present invention in which the so-called “preferential treatment” by this disclosure is provided across the board to all users who connect to contact center 150.

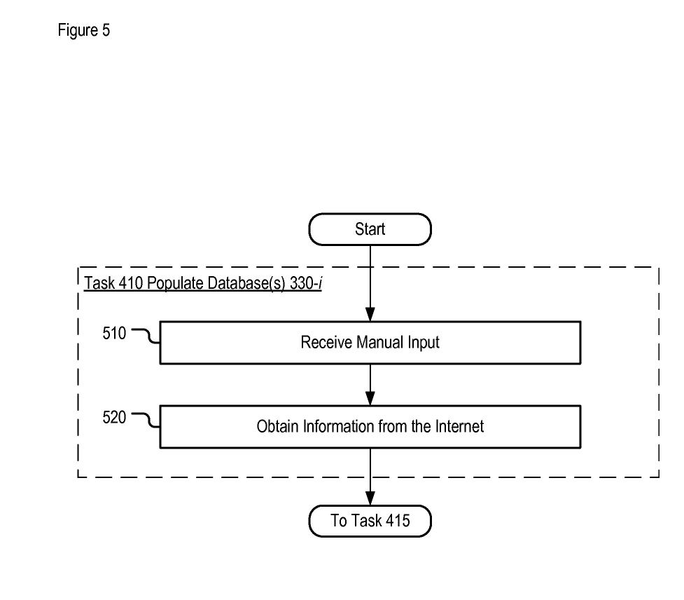

At task 410, database(s) 330-i are populated with at least one of (1) a user characteristic, (2) agent characteristic, and (3) transaction characteristic. The information is loaded into the databases in two ways: it is loaded manually by human agents (e.g., users, agents, administrators, etc.); or it is obtained by mining the Internet for information. Task 410 is further described in the discussion with respect to FIG. 5.

At task 415, a communication session between contact center 150 and terminal 110-1 is established. In accordance with the illustrative embodiment of the present invention, the communication session is a telephone call, but it will be clear to those skilled in the art, after reading this disclosure, how to make and use alternative embodiments of the present invention in which the communication session is of another type, such as, for example, a text chat session (i.e., an Internet chat), short message service (SMS) exchange, video call, etc.

At task 420, contact center 150 obtains an identifier for the user of terminal 110-1-user 105-1. The identifier is used to search databases 330-i and/or the Internet for user and transaction characteristics. In accordance with the illustrative embodiment of the present invention, the identification is an endpoint identifier associated with terminal 110-1. However, it will be clear to those skilled in the art, after reading this disclosure, how to make and use alternative embodiments of the present invention in which an alternative identifier is obtained (e.g., account number, social security number, name, etc.). In some of these embodiments, the alternative identifier is determined by performing a database search with the identifier for terminal 110-1 used as part of the search key.

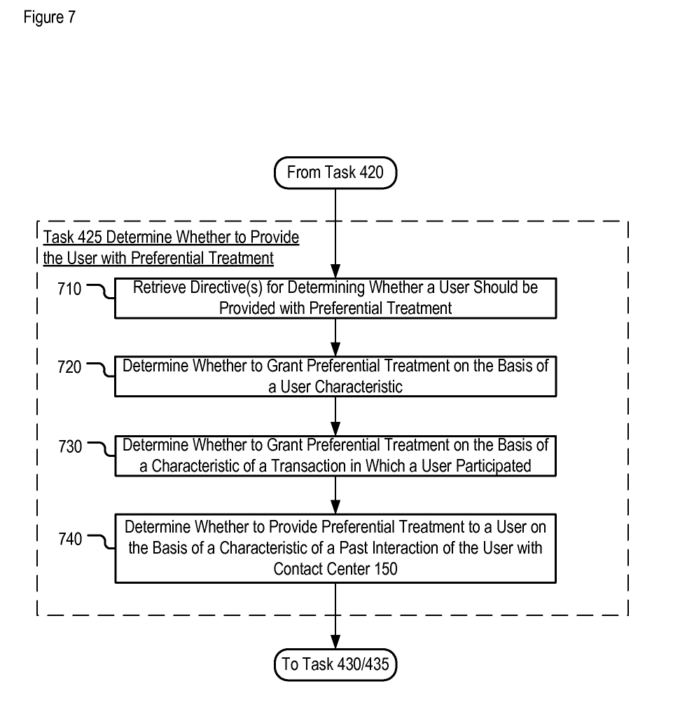

At task 425, contact center 150 determines whether to provide user 105-1 with preferential treatment. If contact center determines that user 105-1 is entitled to preferential treatment, contact center 150 proceeds to execute task 430. Otherwise, contact center 150 executes task 435. The manner in which contact center 150 determines whether to provide user 105-1 with preferential treatment is further described in the discussion with respect to FIG. 7.

At task 430, contact center 150 provides user 105-1 with preferential treatment. The preferential treatment is a treatment that is specific to the present invention. The preferential treatment is provided in one of the following methods:
(1) an agent is deliberately selected to serve user 105-i,
(2) the execution of an interactive communication script is bypassed for user 105-i,
(3) a customer service script from which agents 190-i read is customized for the user,
(4) the user is allowed to personally specify the characteristics of an agent to whom the user wishes to be connected,
(5) the user is presented with a set of agent profiles and allowed to select the agent to whom the user wishes to be connected,
(6) an Internet search is performed to obtain information about the user, and
(7) any other method described in this disclosure.

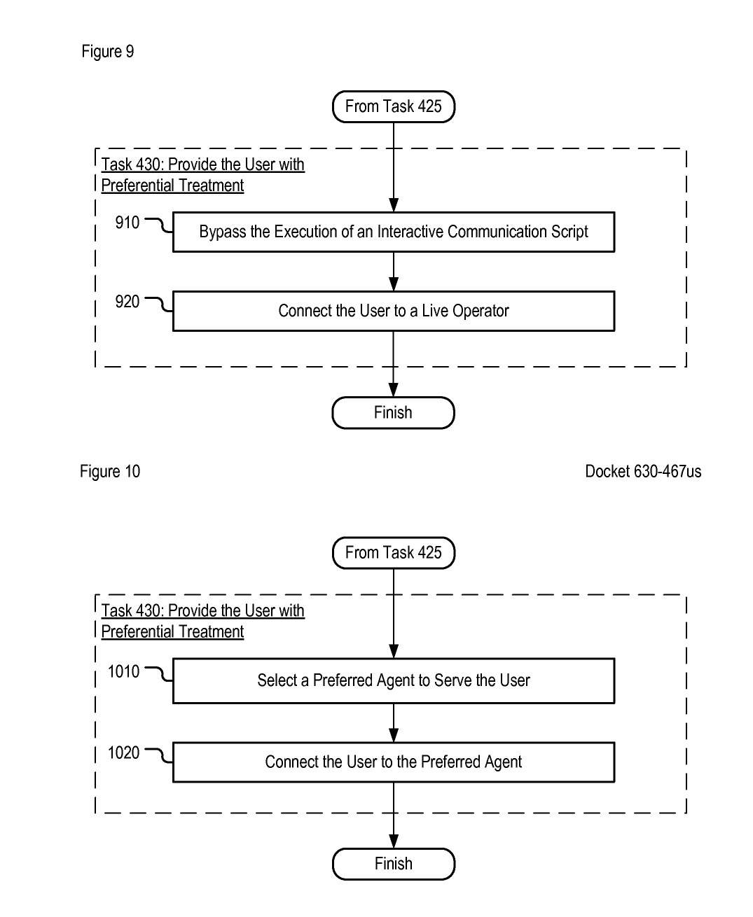

The manner in which each of the above preferential treatments is provided is further described in the discussion with respect to FIGS. 9-11.

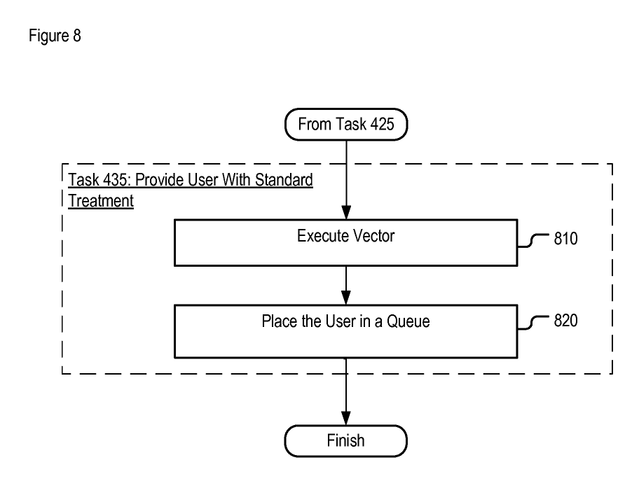

At task 435 contact center 150 provides user 105-1 with a standard treatment. The standard treatment is the type of treatment that is ordinarily provided by contact centers known in the art. Task 435 is further described in the discussion of FIG. 8.

FIG. 5 depicts a flowchart of the execution of the salient subtasks associated with the performance of task 410. It will be clear to those skilled in the art, after reading this disclosure, how to perform the tasks associated with FIG. 5 in a different order than represented or to perform one or more of the tasks concurrently. Furthermore, it will be clear to those skilled in the art, after reading this disclosure, how to make and use alternative embodiments of the present invention that omit one or more of the tasks.

At task 510, information is manually stored in database(s) 330-i. The stored information represents at least one of a user characteristic, agent characteristic, or a transaction characteristic. The information is manually entered by one of: users 105-i, agents 195-i, or an administrator of contact center 150 into an input interface which allows the storage of information in database(s) 330-i.

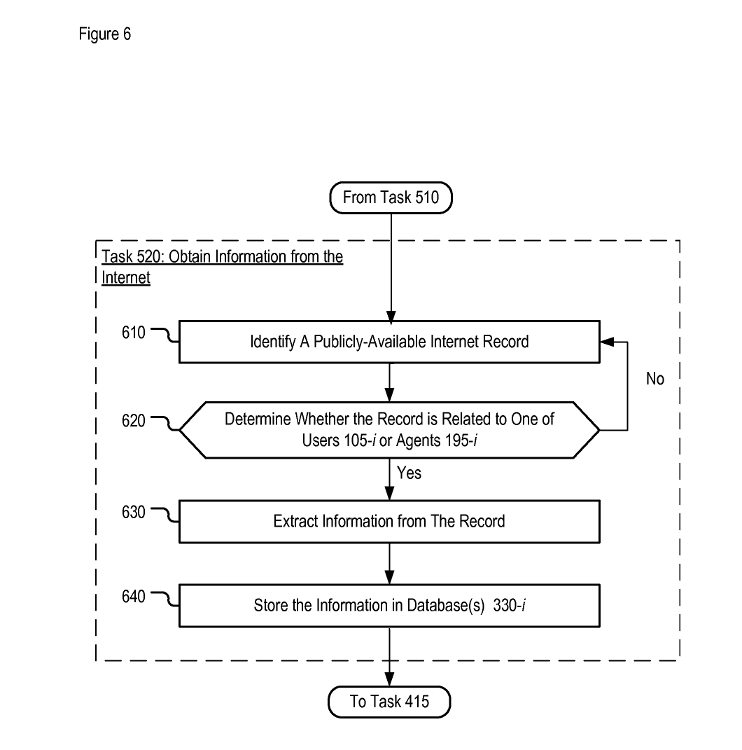

At task 520, switch controller 240 searches the Internet for records that are publicly available. After the records are located, switch controller 240 processes them to identify at least one of a (1) user characteristic, (2) agent characteristic, and (3) transaction characteristic. Task 520 is further described in the discussion with respect to FIG. 6.

At task 530, switch controller retrieves at least one of (1) a user characteristic, (2) agent characteristic, and (3) transaction characteristic. The characteristics are retrieved by connecting to an information-collecting software application. The information-collecting application is executing on the communications terminal of one of user(s) 105-i or agent(s) 195-i. The information-collecting application monitors data that is downloaded onto the communication terminal when the user of the terminal is connected to websites of interest (e.g., MySpace™, etc.). In addition, the information-collecting application processes the downloaded information to identify user, agent or transaction characteristics that are represented in it. Furthermore, the information-collecting application monitors input that is entered by the user of the communication terminal and processes the input to identify any user, agent or transaction characteristics that are indicated in it. It will be clear to those skilled in the art, after reading this disclosure, how to process the data that is monitored by the information-collecting application.

FIG. 6 depicts a flowchart of the execution of the salient subtasks associated with the performance of task 520. It will be clear to those skilled in the art, after reading this disclosure, how to perform the tasks associated with FIG. 6 in a different order than represented or to perform one or more of the tasks concurrently. Furthermore, it will be clear to those skilled in the art, after reading this disclosure, how to make and use alternative embodiments of the present invention that omit one or more of the tasks.

In particular, FIG. 6 depicts the tasks associated with populating databases 330-i. In accordance with the illustrative embodiment of the present invention, switch controller 240 searches for and collects information that is available on the Internet in an automated methodical manner. This is known as web crawling. The information collected as a result of the web crawling is stored in database(s) 330-i and is later used in selecting the appropriate agents to assist user(s) 105-i.

The salient tasks performed by switch controller 240 in crawling the Internet are:
(1) identify an information record,
(2) determine if the record is related to a person of interest—i.e., user 105-i or agent 195-i.
(3) If yes, extract at least one of a user characteristic, agent characteristic, or transaction characteristic from the information record.
(4) store the extracted characteristic(s) in database(s) 330-i.

These tasks are further discussed below:

At task 610, switch controller 240 identifies, on the Internet, a record of information about a person. In accordance with the illustrative embodiment of the present invention, the record is a user profile found on a social networking portal, such as MySpace™ or Linkedin™. However, it will be clear to those skilled in the art, after reading this disclosure, how to make and use alternative embodiments of the present invention in which the information record comprises any information related to the person, such as, for example, and without limitation, news-articles about the person, content that is authored by the person, such is blog posts or product reviews posted on shopping websites (e.g, Amazon™, etc.) and so forth.

At task 620, switch controller 240 determines whether the person is one of users 105-i or agents 195-i. In accordance with the illustrative embodiment of the present invention, switch controller 240 matches an identifier for one of agents 195-i or users 105-i (e.g., the identifier obtained at task 415, etc.) to information identifying the owner or subject of the identified record. In accordance with the illustrative embodiment of the present invention, identifiers for users 105-i are obtained from customer records which businesses normally keep. It will be clear to those skilled in the art how to provide such records to switch controller 240, as well as program it to match the customer identifiers to information that is found on the Internet. The identifiers for agents 195-i are obtained from similar records.

When switch controller 240 determines that the identified record is related to one of users 105-i or agents 195-i, it proceeds to execute task 630. Otherwise, it executes task 610 again.

At task 630, switch controller 240 extracts at least one of (1) a user characteristic, (2) agent characteristic, and (3) transaction characteristic from the identified record. In executing task 630, switch controller 240 processes the information contained in the record to determine whether it represents any user, agent, or transaction characteristics. In accordance with the illustrative embodiment of the present invention, the processing of the information of the records is performed by searching for predetermined keywords and relating the keywords to specific characteristics. However, the present invention is not limited to any particular method for analyzing the content of records located at task 610 (e.g., social network profiles, product reviews, etc.). It will be clear to those skilled in the art how to process any records that are identified at task 610 in order to extract information from them.

In some alternative embodiments of the present invention, switch controller 240 extracts product ratings from product reviews which are posted by users 105-i. As is well known, many shopping websites allow their customers to comment on the purchases which they make or have made. As part of their comments, customers provide discrete ratings for products purchased (e.g., one (1) star being the lowest and five (5) stars the highest, e.g.). The alternative embodiments in question specifically locate such ratings and treat them as important transaction characteristics.

Nevertheless, it should be noted that the present invention is not limited to extracting ratings from product reviews. It will be clear to those skilled in the art, after reading this disclosure, how to make and use further alternative embodiments of the present invention in which any type of transaction or user characteristic is extracted from product reviews that are posted by users 105-i (e.g., type of product purchased, date of purchase, etc.).

At task 640, switch controller stores the extracted information in at least one of database(s) 330-i.

FIG. 7 depicts a flowchart of the execution of the salient subtasks associated with the performance of task 425. It will be clear to those skilled in the art, after reading this disclosure, how to perform the tasks associated with FIG. 7 in a different order than represented or to perform one or more of the tasks concurrently. Furthermore, it will be clear to those skilled in the art, after reading this disclosure, how to make and use alternative embodiments of the present invention that omit one or more of the tasks.

In particular, FIG. 7 depicts a flowchart associated with the execution of the salient tasks associated with determining whether to provide user 105-1 with preferential treatment. In accordance with the illustrative embodiment of the present invention whether to provide preferential treatment is determined on the basis of at least one of:
(1) a user characteristic, and
(2) a transaction characteristic.

As the disclosure explains, the characteristics are obtained by (i) querying database(s) 330-i or (ii) searching the Internet in the manner discussed with respect to task 720 or (iii) any combination of i and ii.

When a user 105-1 is granted preferential treatment, it is connected to a specified contact center agent. Put differently, in accordance with the illustrative embodiment of the present invention, an agent is selected to serve user 105-1 on the basis of a user characteristic. The salient tasks associated with determining whether to provide preferential treatment to user 105-1 are discussed below:

At task 710, vectoring system 220 retrieves at least one directive for determining whether a user should be given a preferential treatment. The directive is a rule which governs the granting preferential treatment. In accordance with the illustrative embodiment of the present invention, the directives are encoded in extensible markup language (XML) format, but it will be clear to those skilled in the art how to make and use alternative embodiments of the present invention in which the directives are encoded in another machine readable format.

In accordance with the illustrative embodiment of the present invention, three directives are retrieved:
(1) provide user with preferential treatment, if the user lives on Maple Shade Drive,
(2) provide user with preferential treatment, if the user purchased a Blu-ray Disk player prior to March 2007, and
(3) provide user with preferential treatment if there is a record of agent skill selection that is made by the user during a past communication session with contact center 150.

In accordance with the illustrative embodiment of the present invention, vectoring system 220 retrieves the directives from its physical memory. However, it will be clear to those skilled in the art, after reading this disclosure, how to make and use alternative embodiments of the present invention in which the directive is retrieved from a remote server.

At task 720, vectoring system 220 executes the first directive for determining whether to provide preferential treatment to user 105-1. The first directive provides that preferential treatment should be provided to all users who live on Maple Shade Dr. In executing the first directive, vectoring system 220 retrieves a record associated with user 105-1 from user database 330-1. If the record indicates that the user lives on the specified address, vectoring system 220 accords user 105-1 a preferential treatment.

Although, the directive for determining whether to provide user 105-1 involves consideration of an address, it will be clear to those skilled in the art, after reading this disclosure, how to make and use alternative embodiments of the present invention in which the directive involves consideration of any user characteristic. Examples of alternative directives for determining whether to provide user 105-1 with preferential treatment include:
(1) provide preferential treatment, if account number starts with 500,
(2) provide preferential treatment, if user income exceeds a threshold, and
(3) provide preferential treatment, if age of user is employed at company X.

Notably, in accordance with the illustrative embodiment of the present invention, vectoring system 220 queries user database 330-1 in order to obtain information about the characteristic of user 105-1 (the user address). However, it will be clear to those skilled in the art, after reading this disclosure, how to make and use alternative embodiments of the present invention in which the user characteristic is obtained from an alternative source—an Internet source. In these embodiments of the present invention, vectoring system 220 obtains characteristics of user 105-1 from records that are available on the Internet (e.g., MySpace™ profile, product reviews that were posted by the user on shopping websites, etc.).

In one such alternative embodiment vectoring system 220 deliberately searches the Internet, at task 720, for records related to user 105-1. In accordance with this embodiment, vectoring system 220 performs a search of a social networking portal (e.g., MySpace™, etc.) to obtain the profile of user 105-1. The search for the user profile is performed by using a search key that is based on an identifier for user 105-1 and/or a characteristic of user 105-1. In accordance with the alternative embodiment of the present invention, the identifier for the user can be the identifier obtained at task 415. Furthermore, in accordance with the alternative embodiment of the present invention, the characteristic used in the search key is any characteristic that is stored in databases 330-i when tasks 510 and/or 520 of FIG. 5 are executed.

In another alternative embodiment of the present invention, at task 720, vectoring system 220 identifies a record that is related to user 105-1, by performing a general search engine query (e.g., Google™ search, etc.) for information related to user 105-1. And in a yet another alternative embodiment of the present invention, at task 720, vectoring system 220 locates a record that is related to user 105-1, by searching the databases of online shopping websites like Amazon™ for product reviews that are posted by user 105-1. Those skilled in the art will readily recognize, that further alternative embodiments of the present invention can be devised in which any source that is available on the Internet is searched for information that is related to user 150-1 (e.g., university websites, news outlets, etc.).

Any records related to user 105-1 are found to exist on the Internet, the information in them is processed in order to identify user characteristics which it potentially represents. The processing is performed in the manner discussed with respect to task 630 of FIG. 6.

At task 730, vectoring system 220 executes the second directive for determining whether to provide preferential treatment for user 105-1. The second directive provides that a preferential treatment should be granted to users who made a purchase prior to a specified date. In executing the second directive, vectoring system 220 searches the records in transaction database 330-1 to determine whether the condition of the second directive is met. If the condition is met, vectoring system 220 accords user 105-1 a preferential treatment.

Although, the directive for determining whether to provide user 105-1 with preferential treatment involves consideration characteristics of a purchase, it will be clear to those skilled in the art, after reading this disclosure, how to make and use alternative embodiments of the present invention in which the directive involves consideration of any transaction characteristic. Examples of alternative directives for determining whether to provide user 105-1 with preferential treatment include:
(1) provide preferential treatment, if the total of all purchases made by the user during a time period (e.g. 1 month, 1 year, etc.) exceeds a specific sum,
(2) provide preferential treatment, if user purchased a product at a specific location,
(3) provide preferential treatment, if user purchased vehicle of a specified brand, and
(4) provide preferential treatment, if user, in a product review posted on a website, gave a low rating to a specific product (e.g., 1 star, 5 stars, etc.).

Notably, in accordance with the illustrative embodiment of the present invention, vectoring system 220 queries transaction database 330-3 in order to obtain information the transaction characteristic (i.e., the purchase date). However, it will be clear to those skilled in the art, after reading this disclosure, how to make and use alternative embodiments of the present invention in which vectoring system 220 obtains the transaction characteristic by searching Internet sources in much the same fashion as described in the discussion with respect to task 720.

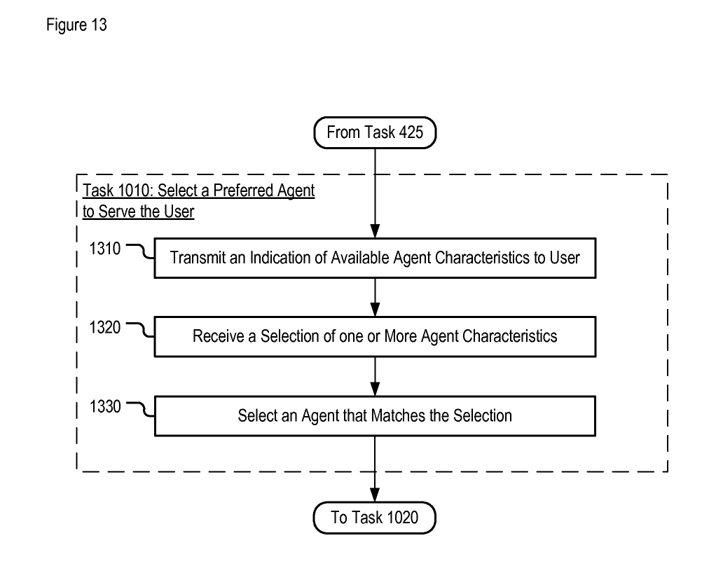

At task 740, vectoring system 220 executes the third directive for determining whether to provide preferential treatment for user 105-1. The third directive provides that a preferential treatment is to be granted if contact center 150 is in possession of a record of an agent skill selection that is made by the user. Specifically, contact center searches user database 330-1 to determine the availability of past selections of agent characteristics. Agent characteristic selection is elaborated on in the discussion with respect to FIG. 13.

FIG. 8 depicts a flowchart of the execution of the salient subtasks associated with the performance of task 435. It will be clear to those skilled in the art, after reading this disclosure, how to perform the tasks associated with FIG. 8 in a different order than represented or to perform one or more of the tasks concurrently. Furthermore, it will be clear to those skilled in the art, after reading this disclosure, how to make and use alternative embodiments of the present invention that omit one or more of the tasks.

At task 810, vectoring system 220 executes a vector in order to select an appropriate queue for user 105-1. A vector is one type of interactive communication script. Specifically, it is a set of commands that define the processing of a call by vectoring system 220. In accordance with the illustrative embodiment of the present invention, the following vector is executed:
10: Play Announcement: “If you are calling about problems with a television set that was purchased from us press one (1). If you are calling about a personal computer that was purchased from us press two (2)”;
20: Receive input from caller;
30: If the input is one (1), place the user in Queue 1;
40: If the input is two (2), place the user in Queue 2;

At task 820, vectoring system 220 instructs switch controller 240 to place a record corresponding to user 105-1 in queue 310-1.

FIG. 9 depicts a flowchart of the execution of the salient subtasks associated with the performance of task 430 by a first illustrative embodiment of the present invention. It will be clear to those skilled in the art, after reading this disclosure, how to perform the tasks associated with FIG. 9 in a different order than represented or to perform one or more of the tasks concurrently. Furthermore, it will be clear to those skilled in the art, after reading this disclosure, how to make and use alternative embodiments of the present invention that omit one or more of the tasks.

At task 910, vectoring system 220 bypasses the execution of an interactive communication script. In accordance with the illustrative embodiment of the present invention, vectoring system 220 omits the execution of the vector described with respect to task 810 and connects user 101-5 with a live operator. The operator asks the user questions and obtains the information which would otherwise be collected by the vector of task 810. Subsequently, the operator connects the user to one of agents 195-i. Although, in accordance with the illustrative embodiment of the present invention, user 101-5 is connected to a live operator, it will be clear to those skilled in the art, after reading this disclosure, how to make and use alternative embodiments of the present invention in which user 105-1 is connected to one of agents 195-i directly (without going through a live operator first).

It should be noted that the vector of task 810 is just one type of an interactive communication script. Those skilled in the art readily recognize, after reading this disclosure, that alternative embodiments of the present invention can be devised which the execution of any automated script that is used to obtain information from a user is bypassed. For example, and without limitation, such scripts include other types of interactive voice response (IVR) scripts, Internet-based questionnaires, and others.

At task 920, switch controller 240, in a well known fashion, sets up a connection between user 101-5 and the live operator.

FIG. 10 depicts a flowchart of the execution of the salient subtasks associated with the performance of task 430 by a second illustrative embodiment of the present invention. It will be clear to those skilled in the art, after reading this disclosure, how to perform the tasks associated with FIG. 10 in a different order than represented or to perform one or more of the tasks concurrently. Furthermore, it will be clear to those skilled in the art, after reading this disclosure, how to make and use alternative embodiments of the present invention that omit one or more of the tasks.

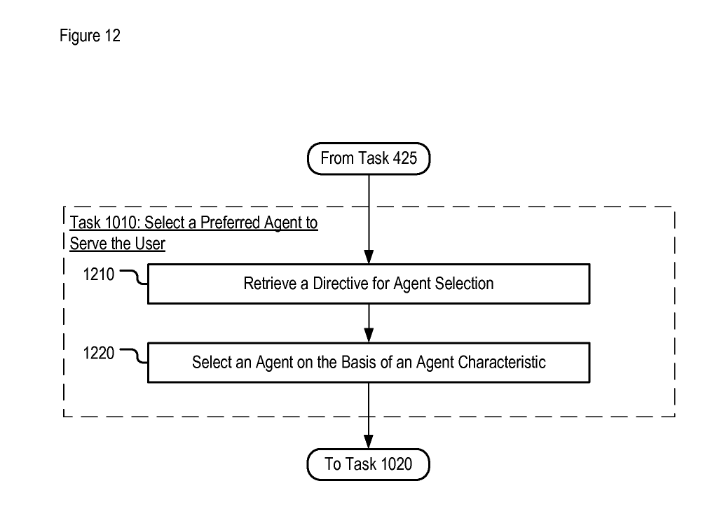

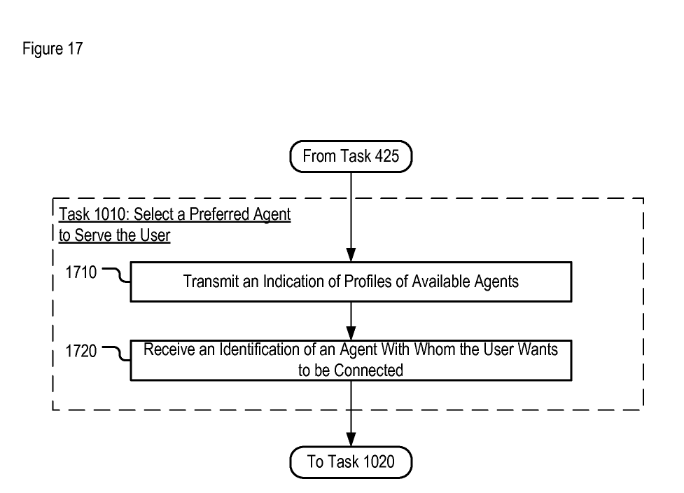

At task 1010, vectoring system 220 selects a preferred agent to serve user 105-1. The selection of a preferred agent is characterized by the execution of extra and/or different tasks from those that are executed in the selection of agents during the course of ordinary treatment of agents. In other words, for the purposes of this disclosure, a “preferred agent” is one who is selected by executing one of the methods described in the discussions with respect to FIG. 12, FIG. 13 and FIG. 17.

Depending on the different embodiments of the present invention, three methods for the selection of a preferred agent are provided. The first method is characterized by selecting an agent on the basis of an agent characteristic. The agent characteristic is obtained by (1) searching agent database 330-2 or (2) performing a search for information about the agent that is available on the Internet. The second method involves selecting an agent on the basis of an “agent skill selection” that is submitted by users 105-i. The third method is characterized with presenting user 105-1 with a set of profiles for agent(s) 195-i and letting the user personally select the agent to whom the user would like to be connected based on the information that is in these profiles. The first method is further described in the discussion with respect to FIG. 12. The second method is described in the discussion with respect to FIG. 13. The third method is described in the discussion with respect to FIG. 17.

At task 1020, vectoring system 220, connects user 105-1 with the preferred agent. In accordance with the illustrative embodiment of the present invention, vectoring system 220 instructs switch controller 240 to store a record corresponding to user 105-1 in one of queues 340-i. However, it will be clear to those skilled in the art, after reading this disclosure, how to make and use alternative embodiments of the present invention in which user 101-5 is connected to the preferred agent directly without being placed in a call waiting queue first.

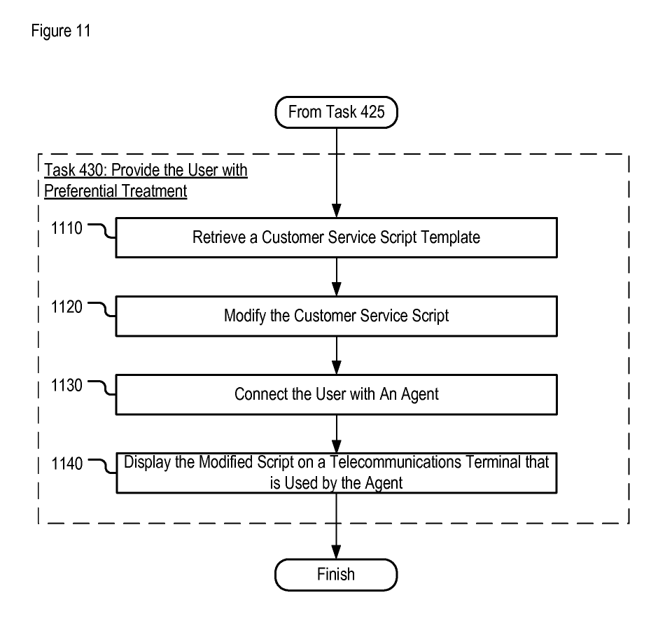

FIG. 11 depicts a flowchart of the execution of the salient subtasks associated with the performance of task 430 by a third illustrative embodiment of the present invention. It will be clear to those skilled in the art, after reading this disclosure, how to perform the tasks associated with FIG. 11 in a different order than represented or to perform one or more of the tasks concurrently. Furthermore, it will be clear to those skilled in the art, after reading this disclosure, how to make and use alternative embodiments of the present invention that omit one or more of the tasks.

At task 1110, vectoring system 220 retrieves a customer service script template. A customer service script is a sequence of questions and responses which agent 195-i is required to use when communicating with users 105-i. In accordance with the illustrative embodiment of the present invention, customer service scripts provide the type of greeting which agents are supposed to use, as well as the precise questions which agents need to ask in order to most effectively resolve the problem of customer 105-i. The use of customer service scripts is well known in the art.

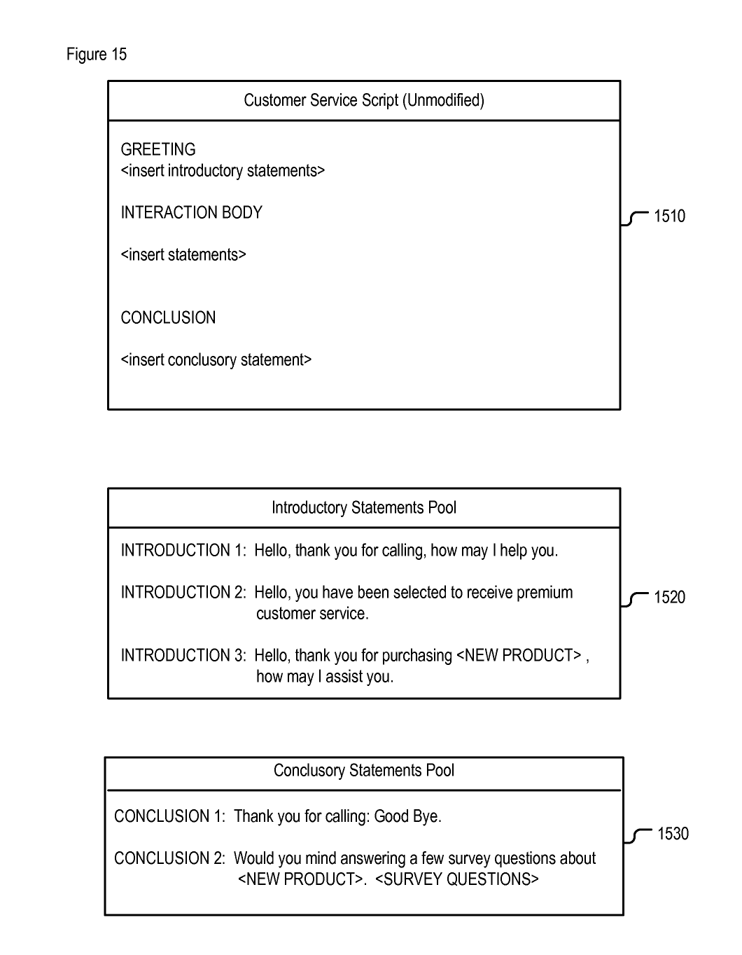

A customer service script template is a template which includes placeholders for different declarative statements and questions which agent 195-i is required to communicate to user 105-i. An example of a customer service template is depicted in FIG. 15.

FIG. 15 depicts customer service script template 1510, introductory statements pool 1520, and conclusion pool 1530.

Customer script template 1510, as noted, is a document which specifies the general structure of conversations between agents 195-i and users 105-i. In accordance with the illustrative embodiment of the present invention, the template comprises a greeting, body, and conclusion sections. Each section comprises a placeholder for the insertion of particular statements (i.e. either declarative statements or questions) which agent 195-i is required to make to user 105-i during their communications.

Conclusion pool 1520 is a selection of three possible introductions which agent 195-i can use at the beginning of his or her communication with user 105-i. Each one of the three statements can be used to replace the introduction placeholder.

Introduction pool 1530 is a selection two possible conclusions which agent 195-i can use at the end of his or her communication with user 105-i. Each of the three statements can be used in place of the conclusion placeholder.

It should be noted that customer script service template 1510, introduction pool 1520, and conclusion pool 1530 are provided only as an example. The present invention is not limited to any particular content of the customer service script template. The customer service script templates that are used in conjunction with the present invention is expected to be selected by the administrators of contact center 150. It is well understood by those skilled in the art how to devise and use customer service scripts.

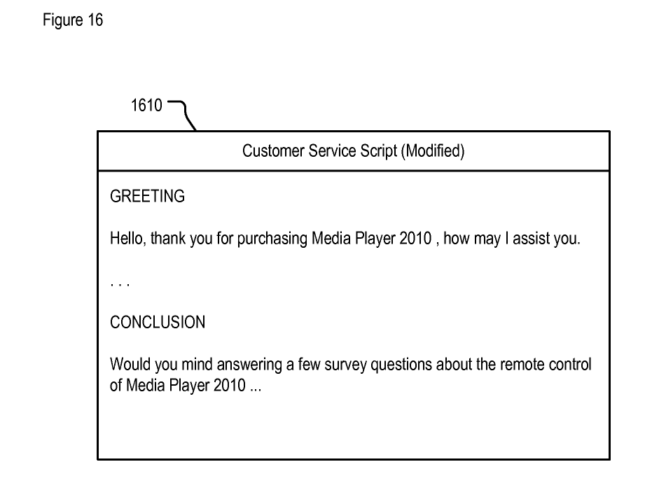

Returning to the discussion of FIG. 11. At task 1120, vectoring system 220 modifies the customer service script template to produce a modified customer service script. The modified customer service script is depicted in FIG. 16. As shown, script 1610 comprises a greeting section which includes a greeting instead of placeholder. The same is true for the conclusion section of the script.

Specifically, at task 1120, vectoring system 220 retrieves two directives for modifying the customer service script template. The first directive provides what information should be put in place of the introduction placeholder. The second directive provides what information should be put in place of the conclusion placeholder.

In accordance with the illustrative embodiment of the present invention, the directives for modifying customer service template 1710 are encoded in extensible markup language (XML) format, but it will be clear to those skilled in the art how to make and use alternative embodiments of the present invention in which the directives are encoded in another machine readable format.

In accordance with the illustrative embodiment of the present invention, the following directives are retrieved by vectoring system 220:

insert INTRODUCTION 3 in the introduction section of the customer service template;

insert CONCLUSION 2 in the conclusion section of the customer service template.

Although, in accordance with the illustrative embodiment of the present invention, vectoring system 220 retrieves two directives, it will be clear to those skilled in the art, after reading this disclosure, how to make and use alternative embodiments of the present invention which any number of directives is retrieved (e.g., 1, 3, 10, 20, etc.) Furthermore, it will be clear to those skilled in the art, after reading this disclosure, how to make and use alternative embodiments of the present invention in which the directives concern the modification of any part of the customer service script template, such as the body, for example. The body section contains statements that are designed to guide the user through explaining his or her problem, as well as resolving it.

It should be noted that the present invention is not limited to any particular method for modifying customer service scripts. Although, in accordance with the illustrative embodiments of the present invention, the customer service script is modified by using a template, placeholders, and statement selection pools, those skilled in the art will readily recognize, after reading this disclosure, that alternative embodiments can be devised in which the modification of customer service scripts is performed differently.

For instance, in accordance with one such alternative embodiment of the present invention, a customer service script is modified by inserting additional statements into an existing customer service script (rather than substituting placeholders with the actual statements). Further alternative embodiments can be devised in which customer service scripts are modified by deleting statements from already existing scripts. And yet further alternative embodiments of the present invention can be devised in which the modification of the customer service script is performed by replacing individual words.

At task 1130, contact center 150 connects user 105-i with agent 195-i. It will be clear to those skilled in the art how to execute task 1130.

At task 1140, contact center 150 displays the modified customer service script on the communications terminal of the agent to which user 105-1 is connected at task 1130. In accordance with the illustrative embodiment of the present invention, the text of the modified script is displayed on a monitor of the communications terminal, but it will be clear to those skilled in the art how to make and use alternative embodiments of the present invention in which the script is rendered in another medium, such as audio, for example. In any event, it will be clear to those skilled in the art how to execute task 1140.

FIG. 12 depicts a flowchart of the execution of the salient subtasks associated with the performance of task 1010 by a fourth illustrative embodiment of the present invention. It will be clear to those skilled in the art, after reading this disclosure, how to perform the tasks associated with FIG. 12 in a different order than represented or to perform one or more of the tasks concurrently. Furthermore, it will be clear to those skilled in the art, after reading this disclosure, how to make and use alternative embodiments of the present invention that omit one or more of the tasks.

At task 1210, vectoring system 220 retrieves at least one directive for selecting a preferred agent. The directive is a rule which governs whether a user is to be given preferential treatment. In accordance with the illustrative embodiment of the present invention, the directive is encoded in extensible markup language (XML) format, but it will be clear to those skilled in the art how to make and use alternative embodiments of the present invention in which the directives are encoded in another machine readable format.

In accordance with the illustrative embodiment of the retrieved directive provides that an agent with at least 10 years of experience on the job should be selected. Although, in accordance with the illustrative embodiment of the present invention, the preferred agent is selected on the basis of experience level, it will be clear to those skilled in the art, after reading this disclosure, how to make and use alternative embodiments of the present invention in which the preferred agent is selected on the basis of any agent characteristic.

At task 1220, vectoring system 220 executes the directive retrieved at task 1220. In particular, vectoring system searches agent database 330-2 in order to identify an agent with the requisite experience. When such agent is identified, vectoring system executes task 920.

Although, in accordance with the illustrative embodiment of the present invention, searches agent database 330-2, those skilled will readily recognize that alternative embodiments of the present invention can be devised in which vectoring system 220 identifies a characteristic of an agent by searching for information about the agent that is available on the Internet according to the methods described in the discussion with respect of task 720 of FIG. 7.

FIG. 13 depicts a flowchart of the execution of the salient subtasks associated with the performance of task 1010 by a fourth illustrative embodiment of the present invention. It will be clear to those skilled in the art, after reading this disclosure, how to perform the tasks associated with FIG. 13 in a different order than represented or to perform one or more of the tasks concurrently. Furthermore, it will be clear to those skilled in the art, after reading this disclosure, how to make and use alternative embodiments of the present invention that omit one or more of the tasks.

At task 1310, vectoring system 220 transmits at least one indication of a characteristic of one of agents 195-i. The indication is transmitted to the communication terminal of user 105-1. In accordance with the illustrative embodiment of the present invention, the agent characteristics are agent skills. An agent skill is an ability, knowledge, experience or understanding which an agent possesses. The indication of available agent skills that is transmitted to the terminal of user 105-1 identifies at least one agent skill that is possessed by at least one of agents 195-i. Although indications of agents skills are transmitted in the illustrative embodiment of the present invention, it will be clear to those skilled in the art, after reading this disclosure, in which any agent characteristic that is available in agent database 320-2 is transmitted at task 1310 (e.g., characteristics that describe agent's education, etc.).

In accordance with the illustrative embodiment of the present invention, vectoring system 220 determines what characteristics to be transmitted to terminal 110-1 by querying agent database 330-2. However, it will be clear to those skilled in the art, after reading this disclosure, how to make and use alternative embodiments of the represent invention in which the set of available skills that is to be transmitted to terminal 110-1 is specified and stored in the memory of contact center 150 by a human operator.

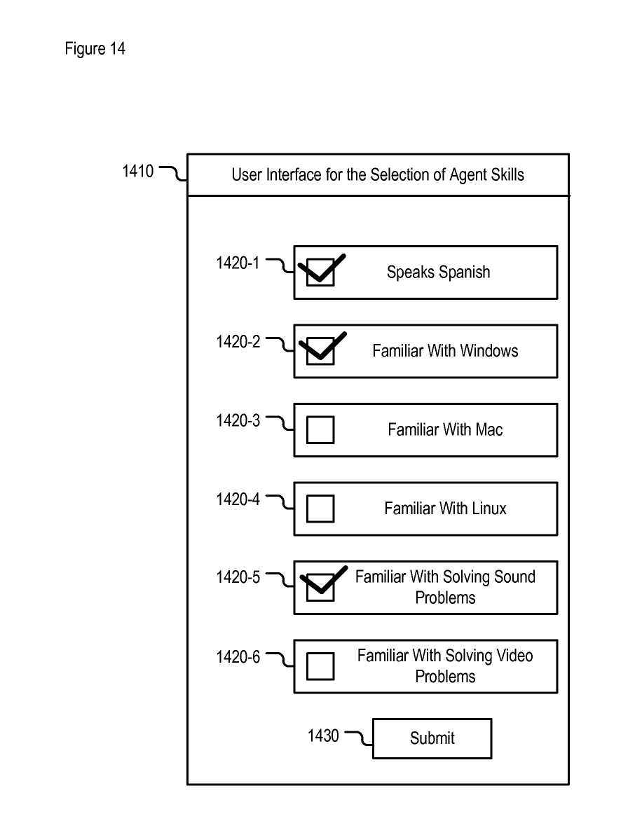

Upon receiving the indication of available agent skills, terminal 110-1 displays a graphical menu which allows user 105-1 to select one or more skills which the user desires the agent to have. The graphical menu is depicted in FIG. 14.

FIG. 14 depicts a graphical user interface (GUI) window 1410 which allows user 101-5 to select specific available skills. The menu comprises box 1420-k and submit button 1430, where k∈{1, 2, 3, 4, 5, and 6}.

Box 1420-k, six of which are depicted in FIG. 14, comprises a checkbox and a corresponding label which identifies an agent skill. When the box is checked, this is an indication that user 105-1 desires the skill identified by the label corresponding to the selected checkbox.

In accordance with the illustrative embodiment of the present invention, checkboxes corresponding to the “Speaks Spanish,” “Familiar with Windows,” and “familiar with Solving Sound Problems” agent skills are checked. This is an indication, that user 105-1 would like to speak with an agent who speaks Spanish, and who is capable of resolving audio problems with the Windows™ operating system.

Submit button 1430 is a graphical user interface (GUI) button. When the button is pressed, terminal 110-1 transmits an indication of selected agent skills back to contact center 150.

Although, in accordance with the illustrative embodiment of the present invention, the characteristics of the available agents are presented to users by means of checkboxes and labels, it will be clear to those skilled in the art, after reading this disclosure, how to make and use alternative embodiments of the present invention in which the characteristics are displayed in an alternative fashion (e.g., by playing audio messages to the users, by displaying graphical icons, etc.). Furthermore, it will be clear to those skilled in the art, after reading this disclosure, how to make and use alternative embodiments of the present invention in which users are allowed to specify the characteristics of agents with whom they want to be connected (e.g., type and submit a string which identified a preferred agent characteristic, etc.); rather than being presented with a list of predetermined characteristics.

At task 1320, contact center 150, receives the user selection of one or more agent skills. It will be clear to those skilled in the art how to execute task 1320.

At task 1330, vectoring system 220 selects an agent that has at least one some of the skills. In accordance with the illustrative embodiment of the present invention, vectoring system 220 searches the records in agent database 330-3 and identifies an agent that possess all of the skills. However, it will be clear to those skilled in the art, after reading this disclosure, how to make and use alternative embodiments of the present invention in which vectoring system 220 uses a more flexible method for identifying a preferred agent:

In one alternative embodiment of the present invention, some agent skills are classified as mandatory and others as optional. For instance, the ability of agent to speak Spanish can be classified as mandatory, while the familiarity of Windows™ is considered optional. Under this arrangement, vectoring system 220 searches the records of agent database 330-2 to identify an agent who possesses the mandatory skills. When more than one agent possesses the mandatory skills, vectoring system 220 selects the agent that possesses the most optional skills.

It will be clear to those skilled in the art that a variety of algorithms and heuristics can be devised for matching a user selection of agent skills to information about agents that is stored in agent database 330-2. The present invention is not limited to any specific one of those algorithms and heuristics.

After it selects a preferred agent, vectoring system 220 proceeds to connect the proffered agent to user 105-1 by executing task 920.

FIG. 17 depicts a flowchart of the execution of the salient subtasks associated with the performance of task 1010 by a fifth illustrative embodiment of the present invention. It will be clear to those skilled in the art, after reading this disclosure, how to perform the tasks associated with FIG. 17 in a different order than represented or to perform one or more of the tasks concurrently. Furthermore, it will be clear to those skilled in the art, after reading this disclosure, how to make and use alternative embodiments of the present invention that omit one or more of the tasks.

At task 1710, vectoring system 220 transmits an indication of profiles for at least two of agents 195-i. Each profile identifies one or more characteristics of one of the agents. In accordance with the illustrative embodiment of the present invention, each profile identifies the name of an agent, his or her experience, education, and human resource id. However it will be clear to those skilled in the art, after reading this disclosure, how to make and use alternative embodiments of the present invention in which any item of information stored in agent database 330-2.

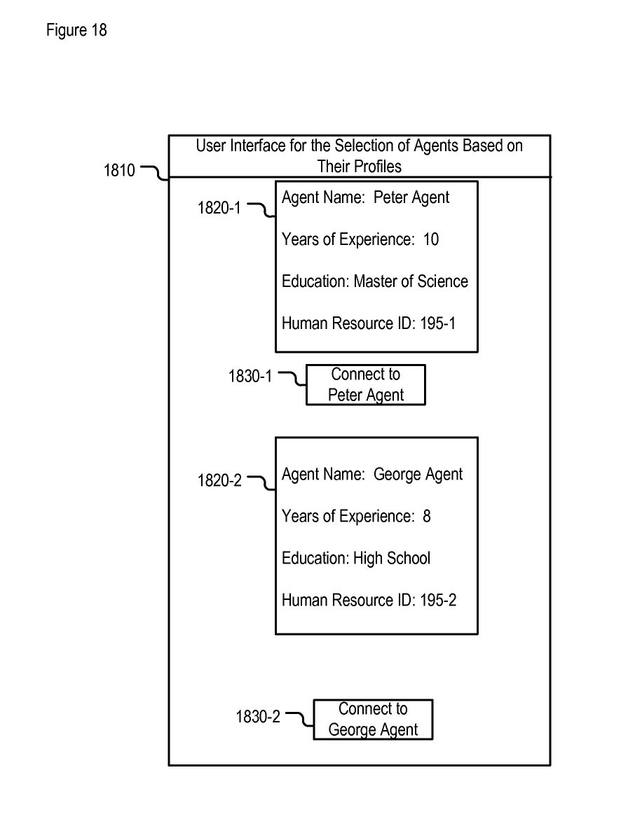

Upon receiving the indication of agent profile(s), terminal 110-1 displays a graphical interface which allows user 105-1 to view the profiles and select a preferred agent based on the agent's profile. The graphical interface is depicted in FIG. 18.

FIG. 18 depicts a graphical user interface (GUI) 1810 for the viewing of agent profiles. The interface, agent profile 1820-l and agent connect button 1830-l, where l∈{1 and 2}. Although the interface displays only two agent profiles it will be clear to those skilled in the art, after reading this disclosure, how to make and use alternative embodiments of the present invention in which the interface comprises any number of agent profiles (e.g., 1, 3, 5, 10, etc.). Furthermore, although, in accordance with the illustrative embodiment of the present invention the agent profiles are presented to the user visually as text, it will be clear to those skilled in the art, after reading this disclosure, how to make and use alternative embodiments of the present invention in which the profiles are presented in an alternative fashion (e.g., by playing audio messages, displaying picture icons, etc.).

Agent profile(s) 1820-l, two of which are depicted in FIG. 18, is a record containing information about one of agents 195-i. In accordance with the illustrative embodiment of the present invention, the agent profile identifies four (4) agent characteristics—name, experience, education, and human resource id—however, it will be clear to those skilled in the art, after reading this disclosure how to make and use alternative embodiments of present invention in which any one of the characteristics stored in agent database 330-2 is included in agent profile 1820-l. Furthermore, it will be clear to those skilled in the art, after reading this disclosure, how to make and use alternative embodiments of the present invention in which any number of characteristics is included in agent profile 1820-l.

Connect button(s) 1830-l, two of which are depicted in FIG. 18, is a graphical user interface (GUI) button. When the button is pressed, terminal 110-1 transmits an identification of an agent that is associated with the button. More specifically, if connect button 1830-1 is pressed, an indication is transmitted by terminal 110-1 that user 105-1 would like to speak with agent 195-1. If connect button 1830-2 is pressed, an indication is transmitted that user 105-1 wishes to communicate with 195-2.

Returning to the discussion of FIG. 17. At task 1720, contact center 150, in a well known fashion, receives the identification of a preferred agent which is transmitted when button 1830-l is pressed.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
transmitting from a contact center:
i. an indication of a first skill, wherein the first skill is possessed by a first agent, and wherein the first agent is associated with a first communications terminal, and
ii. an indication of a second skill, wherein the second skill is possessed by a second agent, and wherein the second agent is associated with a second communications terminal;
receiving at the contact center from a third communications terminal an indication of a third skill;
when the third skill matches the first skill, connecting the third communications terminal to the first communications terminal; and
when the third skill matches the second skill, connecting the third communications terminal to the second communications terminal.

2. The method of claim 1 wherein the indications of the first skill and the second skill are transmitted when the contact center determines that a user of the third communications terminal is to be accorded preferential treatment.

3. A method comprising:
retrieving, at a contact center, an indication of a past selection of a first agent characteristic that is made by a user;
retrieving, at the contact center, a second characteristic of an agent, and
when the first characteristic matches the third characteristic, connecting the user to the agent.

4. A method comprising:
transmitting from a first communications terminal an indication of a first non-empty set of agent characteristics;
receiving at a contact center the indication of the first non-empty set of agent characteristics;
retrieving, at the contact center, a characteristic of an agent, wherein the agent is associated with a second communications terminal; and
connecting the first communications terminal to the second communications terminal when the retrieved agent characteristic matches a characteristic from the first non-empty set of agent characteristics.

5. The method of claim 4 wherein the first non-empty set comprises at least one agent characteristic.

6. The method of claim 4 comprising:
transmitting, from the contact center to the communications terminal an indication of a second non-empty set of agent characteristics, wherein the agent characteristics in the second non-empty set are agent characteristics that are possessed by agents to whom the contact center dispatches incoming communications;
displaying, at the first communications terminal, a menu for the selection of agent characteristics, wherein the menu comprises an indication of a characteristic from the second non-empty set of available agent characteristics; and
wherein the displayed menu is used to include an agent characteristic from the second non-empty set into the first non-empty set.

7. A method comprising:
establishing at a contact center a communications session with a user of a communications terminal;
identifying, at the contact center, a purchase made by the user, wherein the purchase is identified by searching for information related to the user that is publicly available on the Internet; and
connecting the far-end party with an agent, wherein the agent is selected by the contact center based on the time at which the purchase was made.

8. The method of claim 7 comprising:
retrieving at the contact center information about the agent; and
wherein the agent is selected by the contact center based on the retrieved information.

9. The method of claim 7 comprising:
modifying, at the contact center, a script, wherein the modifying operation depends on a characteristic of the purchase; and
displaying the modified script at a communications terminal that is used by the agent to whom the user is connected.

10. A method comprising:
establishing, at a contact center, a communications session with a user of a communications terminal;
transmitting from the contact center to a social networking portal a search query for a profile that is associated with the user;
when a profile associated with the user is found to exist, retrieving information from the profile, wherein the retrieving operation is performed by the contact center; and
bypassing the execution of an interactive communication based on the retrieved information.

11. The method of claim 10 wherein the retrieved information is a user characteristic.

12. The method of claim 10 wherein the retrieved information is a transaction characteristic.

13. A method comprising:
establishing, at a contact center, a communications session with a user of a communications terminal;
connecting the user to an agent, wherein:
i. the agent is selected by the contact center on the basis of information that is accessible over the Internet, and
ii. the information is located by the contact center by performing a search of one or more Internet websites.

14. The method of claim 13 wherein the information is a characteristic of a transaction in which the user has participated.

15. The method of claim 13 wherein the information is a user characteristic.

16. A method comprising:
establishing, at the contact, center a communications session with a user;
retrieving at the contact center information about the user;
modifying, at the contact center, a script, wherein the modifying operation depends on the retrieved information; and
displaying the modified script at a communications terminal of an agent to whom the user is connected.

17. The method of claim 16, wherein the modification comprises at least one of:
adding a question to the script and deleting a question from the script;

18. The method of claim 16, wherein the modification comprises at least one of:
adding a word to the script, deleting a word from the script, and replacing a word in the script.

19. The method of claim 16 wherein the retrieving operation comprises performing an Internet search for information about the user.

20. The method of claim 16 wherein the retrieved information is a user characteristic.

21. The method of claim 16 wherein the information record is a social networking profile.
